(19) United States
(12) Patent Application Publication
(10) Pub. No.: US 2016/0203485 A1
(43) Pub. Date: Jul. 14, 2016

(54) SELECTIVE AUTHENTICATION BASED ON SIMILARITIES OF ECOMMERCE TRANSACTIONS FROM A SAME USER TERMINAL ACROSS FINANCIAL ACCOUNTS

(71) Applicant: CA, INC., New York, NY (US)

(72) Inventors: Revathi Subramanian, San Diego, CA (US); Paul C. Dulany, San Diego, CA (US); Hongrui Gong, San Diego, CA (US); Kannan Shashank Shah, San Diego, CA (US)

(73) Assignee: CA, INC., New York, NY (US)

(21) Appl. No.: 14/592,136

(22) Filed: Jan. 8, 2015

(51) Int. Cl. G06Q 20/40

(52) U.S. Cl. CPC G06Q 20/4016; G06Q 20/405

(57) ABSTRACT

A method of operating a computer system includes receiving from a merchant node an eCommerce authentication request for a pending eCommerce transaction associated with a user terminal. The eCommerce authentication request contains transaction information of the pending eCommerce transaction that includes a user terminal identifier. A risk score for the pending eCommerce transaction is generated based on similarities between the transaction information of the pending eCommerce transaction and a cluster of historical eCommerce transactions each containing transaction information including a user terminal identifier that matches the user terminal identifier of the pending eCommerce transaction. The eCommerce authentication request is selectively provided to an authentication node based on the risk score.

### BACKGROUND

The present disclosure relates to financial transaction processing systems.

Financial transactions relating to purchasing goods and services are predominately paid for using credit accounts and debit accounts that an account owner accesses through associated credit cards and debit cards. Financial transaction processing systems provide verification processes that allow merchants to verify that account information is valid and the account owner has sufficient credit or debit funds to cover the purchase.

When a purchaser is located at the merchant's facility, the merchant is responsible for authenticating that the purchaser is the account owner by, for example, comparing the purchaser's signature to a existing signature on the card, examining a picture ID of the purchaser, or providing a password.

For purchases made through a merchant's website and other electronic commerce (“eCommerce”) transactions (known as a card-not-present transactions (CNP)), financial transaction processing systems can use eCommerce authentication processes that challenge the purchaser to provide a security code that is used to authenticate that the purchaser is the account owner or is otherwise authorized by the account owner. The security code may be a password, personal identification number (PIN), or other information known to the account owner such as a one time password received through e-mail, etc. Purchasers can find eCommerce authentication processes undesirable due to the need to remember security codes and the requirement to successfully complete additional process steps for purchases. Merchants can find eCommerce authentication processes undesirable because of the fees charged for use of such processes and lost sales due to purchasers abandoning transactions during the eCommerce authentication processes.

### SUMMARY

Some embodiments disclosed herein are directed to a method of operating a computer system. An eCommerce authentication request for a pending eCommerce transaction associated with a user terminal is received from a merchant node. The eCommerce authentication request contains transaction information of the pending eCommerce transaction that includes a user device identifier. A risk score for the pending eCommerce transaction is generated based on similarities between the transaction information of the pending eCommerce transaction and a cluster of historical eCommerce transactions each containing transaction information including a user device identifier that matches the user device identifier of the pending eCommerce transaction. The eCommerce authentication request is selectively provided to an authentication node based on the risk score

Some other embodiments disclosed herein are directed to an authentication gateway node that includes a processor and a memory. The memory is coupled to the processor and includes computer readable program code that when executed by the processor causes the processor to perform operations. The operations include receiving from a merchant node an eCommerce authentication request for a pending eCommerce transaction associated with a user terminal. the eCommerce authentication request contains transaction information of the pending eCommerce transaction that includes a user terminal identifier. The operations further include generating a risk score for the pending eCommerce transaction based on similarities between the transaction information of the pending eCommerce transaction and a cluster of historical eCommerce transactions each containing transaction information including a user terminal identifier matching the user terminal identifier of the pending eCommerce transaction. The operations further include selectively provided the eCommerce authentication request to an authentication node based on the risk score.

Some other embodiments disclosed herein are directed to a computer program product that includes a computer readable storage medium having computer readable program code embodied in the medium that when executed by a processor of a computer system causes the computer system to perform operations. The operations include receiving from a merchant node an eCommerce authentication request for a pending eCommerce transaction associated with a user terminal. the eCommerce authentication request contains transaction information of the pending eCommerce transaction that includes a user terminal identifier. The operations further include generating a risk score for the pending eCommerce transaction based on similarities between the transaction information of the pending eCommerce transaction and a cluster of historical eCommerce transactions each containing transaction information including a user terminal identifier matching the user terminal identifier of the pending eCommerce transaction. The operations further include selectively provided the eCommerce authentication request to an authentication node based on the risk score.

Other methods, authentication gateway nodes, and computer program products according to embodiments will be or become apparent to one with skill in the art upon review of the following drawings and detailed description. It is intended that all such additional methods, authentication gateway nodes, and computer program products be included within this description and protected by the accompanying claims.

### BRIEF DESCRIPTION OF THE DRAWINGS

Aspects of the present disclosure are illustrated by way of example and are not limited by the accompanying drawings. In the drawings:

FIG. 1 is a block diagram of a financial transaction processing system that includes an authentication gateway node that controls which eCommerce authentication requests are selected for authentication by an authentication node, in accordance with some embodiments;

FIG. 2 is block diagram illustrating further details of the financial transaction processing system of FIG. 1 that uses an authentication gateway node that trains a non-linear analytical model to control selection of eCommerce authentication requests for authentication in accordance with some embodiments;

FIG. 3 is a block diagram of a neural network model that can be used as the non-linear analytical model to generate a risk score for an eCommerce authentication request based on weight values that are adapted using feedback, in accordance with some embodiments;

FIGS. 4-10 are flowcharts that illustrate operations that may be performed by an authentication gateway node to control which eCommerce authentication requests are authenticated by an authentication node, in accordance with some embodiments; and

FIG. 11 is a block diagram of a computer system that may be incorporated into various components of the system of FIGS. 1-3, in accordance with some embodiments.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

Some embodiments of the present disclosure are directed to a financial transaction processing system that includes an authentication gateway node which identifies a user terminal that has been used to generate eCommerce transaction(s) (e.g., credit card transaction, debit card transaction, bank transaction) which were later determined to be fraudulent or associated with another defined risk factor. When the authentication gateway node observes a subsequent eCommerce transaction arising from the user terminal identifier, it can initiate authentication processes to authenticate a person who is operating the user terminal (e.g., request password, personal identification number, electronic security token, or other secret information known to the account owner) and/or notify a finance issuer node (e.g., credit/debit card bank server) that privileges with an account associated with the eCommerce transaction should be halted/frozen (e.g., cancel card access) or otherwise modified. These and other related embodiments may thereby enable identification of accounts that are at-risk of fraud or other defined risk before those accounts are compromised. Moreover, various embodiments may enable information obtained from processes performed for secure eCommerce transactions, such as credit card transactions, to be used to protect non-secure eCommerce transactions, such as savings and checking transactions.

These and further embodiments will now be explained by way of the following non-limiting example scenarios.

Assume that 9 persons (Person_1 . . . Person_9) have established respective accounts (Account_1 . . . Account_9) with a same credit/debit finance issuer node (e.g., card issuing bank server). Another Person_10 has established Account_10 with a different credit/debit finance issuer node. A fraud person (person attempting fraudulent act) has improperly obtained sufficient information on all of these accounts to be able to attempt eCommerce transactions against the accounts. However, the fraud person attempts to use a same user terminal or user terminals associated with common identification information to carry out those eCommerce transactions.

An authentication gateway node configured according to various present embodiments observes a pattern of eCommerce transactions against Account_1 . . . Account_9 that satisfy a defined rule for identifying fraud or other risk (e.g., a series of small value transactions against Account_1 . . . Account_9 occurring close in time which indicates that account accessibility is being tested) and which arise from the same user terminal or user terminals associated with common identification information. The authentication gateway node responds thereto by initiating security processes directed to safeguarding accounts related to eCommerce transactions arising from the one or more user terminals associated with the common identification information.

The authentication gateway node can initiate the security processes with each of Account_1 . . . Account_9 and, moreover, with any other account that is associated with an eCommerce transaction that is observed in the future to arise from a user terminal associated with the identification information. Moreover, the authentication gateway node use the user terminal identification as a pointer to search among historical transaction information to identify other financial accounts associated with earlier occurring eCommerce transactions arising from the same user terminal or another user terminal satisfying a defined rule relative to the user terminal, and can initiate the security processes with each of those financial accounts. The authentication gateway node may thereby respond to predicted future fraud or other risk with an account and/or identify past fraud or other risk that has not yet been identified by other processes (e.g., account owner reporting fraud). Moreover, although a single fraudulent small value transaction against an account may not be noticed or reported by an account owner or otherwise detected by other security process, the system according to some embodiments can observe a pattern of activity or other information across all monitored eCommerce transactions associated with all credit/debit finance issuer nodes to identify fraud or other risk, and initiate responsive security processes.

When the fraud person operates a user terminal associated with the common identification information to attempt an eCommerce transaction against Account_10, the authentication gateway node determines that it is related through the common identification information of the user terminal to the fraud or other risk observed with Account_1 . . . Account_9. The authentication gateway node can respond by initiating authentication processes to authenticate a person who is operating the user terminal (e.g., request password, personal identification number, electronic security token, or other secret information known to the account owner) and/or by notifying a credit/debit finance issuer node (e.g., card issuing bank server) that privileges with Account_10 should be halted/frozen (e.g., cancel card) or otherwise modified.

The authentication gateway node may thereby effectively detect fraud or other risks with eCommerce transactions for accounts established with any credit/debit issuer nodes that are monitored, and without being limited to whether the eCommerce transactions arise with a same credit/debit finance issuer node. The authentication gateway node can operate independent of any need for sharing of information between different credit/debit finance issuer nodes.

Moreover, the authentication gateway node can use information obtained from processes performed on secure eCommerce transactions, such as credit card transactions which can be secured by authentication processes, to be used to protect non-secure eCommerce transactions, such as bank account transactions.

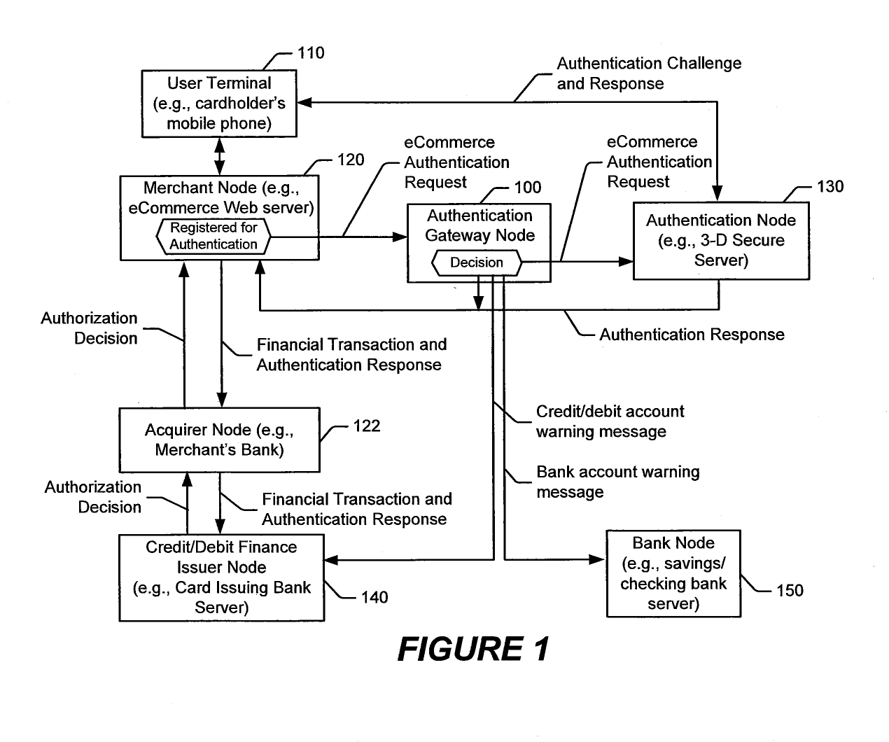

FIG. 1 is a block diagram of a financial transaction processing system that includes an authentication gateway node 100 (e.g., a computer system, computer server or program code executed by another node disclosed herein) that controls which eCommerce authentication requests are authenticated by an authentication node 130 in accordance with some embodiments. Although some embodiments are described in the context of authenticating credit card and/or debit card transactions for purchases made through a merchant's node 120 (e.g., merchant's eCommerce Web server), the embodiments disclosed herein are not limited thereto and can be used with other types of authentication processes.

Referring to FIG. 1, a person who is purchasing an item (purchaser) operates a user terminal 110 to select items to be purchased, and provides (e.g., types, electronically scans, executes an application on the user terminal 100 that outputs, etc.) cardholder information that can include any one or more of: an account number (e.g., credit card number and/or debit card number); customer name; account verification information; cardholder's name; an expiration date for the card; a card verification value (CVV); the cardholder's home address; and the purchaser's shipping address. The cardholder information is communicated by the user terminal 110 to the merchant node 120. The user terminal 110 may be any electronic device that can communicate with a merchant node 120 including, but not limited to, a tablet computer, desktop computer, laptop computer, mobile phone, a point-of-sale merchant terminal, etc.

Because of the prevalence of fraud occurring in eCommerce and other card-not-present financial transactions, where merchants cannot directly authenticate purchasers using picture IDs, electronic authentication processes have been introduced to authenticate purchasers. Electronic authentication processes can be performed by an authentication node 130 to attempt to confirm that the purchaser is an account owner or is otherwise authorized by the account owner.

If the merchant node 120 is registered for use of electronic authentication processes, the merchant node 120 generates an eCommerce authentication request containing content items (also referred to as “items of content”) that includes cardholder information, which can include one or more items of the cardholder information received from the user terminal 100, and may include further information identifying the user terminal 100. In accordance with some embodiments disclosed herein, the cardholder information contained as items of content of the eCommerce authentication request can include any one or more of:
1) purchaser's user terminal identifier (e.g., network address of the user terminal, telephone number of the user terminal, and/or International Mobile Subscriber Identity of the user terminal);
2) account number (e.g., credit/debit card number);
3) expiration date for the card;
4) verification value (e.g., CVV);
5) cardholder's name;
6) the cardholder's home address;
7) the purchaser's shipping address;
8) characteristics of the purchaser's user terminal (e.g., manufacturer, web browser characteristics, and/or operational characteristics);
9) geographic region of the purchaser's user terminal;
10) amount of the financial transaction;
11) identifier for the merchant node 120;
12) a geographic region of the merchant node 120;
13) identifier for the acquirer node 122;
14) time of transaction; and
15) date of transaction.

The identifier for the user terminal may uniquely identify the user terminal, such as by a telephone number of the user terminal and/or a International Mobile Subscriber Identity of the user terminal, which can be determined by the merchant node 120 or another system component and included in the eCommerce authentication request.

The identifier for the user terminal can be defined by a network address associated with the user terminal (e.g., IP address), such as the network address of a network access node (e.g., cable modem, DSL modem, wireless access point, etc), the intermediate routing address of an edge router, and/or another network address that sufficiently defines a group of network locations and/or geographic region from which a user terminal is communicating when performing an eCommerce transaction. The network address may thereby identify a plurality of different user terminals that communicate via the same network access node through the Internet or other data network (e.g., public/private network) with the merchant node 120.

The identifier for the user terminal may additionally or alternatively be a geographic region of the user terminal (e.g., GPS and/or network-assisted determination of location), a user terminal name (e.g., user defined name), a cookie or other information stored on the user terminal during account setup/maintenance with the issuer node and/or the merchant node.

The merchant node 120 communicates the eCommerce authentication request toward the authentication node 130 for authentication processing to authenticate the purchaser. The merchant node 120 may communicate the eCommerce authentication request using a software plug-in provided by a provider of the authentication node 130. Authentication of the purchaser can include determining whether the purchaser possesses secret information that should only be known to the account owner or another person who has been authorized by the account owner to make purchases using the account.

As will be explained in further detail below, an authentication gateway node 100 is disclosed herein that controls which eCommerce authentication requests from the merchant node 120 and other merchant nodes 120 cause authentication of purchasers. The authentication gateway node 100 may also generate a credit/debit account warning message which notifies a credit/debit finance issuer node 140 (e.g., card issuing bank server) that privileges with an account should be halted/frozen (e.g., cancel card) or otherwise modified, and/or may generate a bank account warning message which notifies a bank node 150 (e.g., savings/checking bank server) that privileges with an account should be halted/frozen (e.g., cancel card) or otherwise modified.

The authentication gateway node 100 may intercept the eCommerce authentication request from the merchant node 120 and determine whether authentication will be performed by the authentication node 130. The authentication gateway node 100 may, for example, selectively either route the eCommerce authentication request to the authentication node 130 for authentication or respond to the merchant node 120 without authentication by the authentication node 130 (e.g., some eCommerce authentication requests bypass the authentication node 130). Alternatively, the authentication gateway node 100 may mark the eCommerce authentication requests to indicate whether they are to be authenticated by the authentication node 130 (e.g., all eCommerce authentication requests flow through the authentication node 130 but only some cause authentication). These and other operations by the authentication gateway node 100 are described in further detail below.

Pursuant to one type of authentication process, the authentication node 130 communicates an authentication challenge message to the user terminal 110 which requires the purchaser to enter a security code to complete the purchase. The entered security code is returned to the authentication node 130 in a response message. The security code may be a password, personal identification number (PIN), electronic security token, or other secret information known to the account owner.

The authentication node 130 can compare the security code to an expected code, and apply one or more rules which may be defined by the card issuing bank (referred to more generally as the credit/debit finance issuer node below) to generate an authentication response (e.g., authentication response code) that indicates an outcome of the authentication process.

One type of authentication process is known as a 3-D Secure protocol that can be performed by the authentication node 130 operating as a 3-D Secure authentication server. The 3-D Secure protocol was developed by financial card associations, including Visa and MasterCard, and has become an industry standard. The protocol uses XML messages sent over secure socket layer (SSL) connections between user terminal 110 or other client authentication terminals and the authentication node 130, which can also be referred to as an access control server (ACS). The authentication challenge can be presented through the user terminal 110 to the purchaser within the same web browser window as an in-line session (referred to as an inframe authentication session) or can be presented in a separate window (e.g., pop-up window).

An advantage to merchants of using purchaser authentication is a reduction in “unauthorized transaction” chargebacks. A disadvantage to merchants is that they pay a software setup fee, monthly fee, and per-authentication fee for use of the 3-D Secure access control server provided by the authentication node 130. Moreover, 3-D Secure operation can be complicated and create transaction failures.

Some purchasers view the additional authentication steps as a nuisance or obstacle to completing transactions and/or they erroneously interpret the authentication challenge (e.g., pop-up window) as originating from a fraudulent phishing site/process, which can result in a substantial increase in transaction abandonment by the purchaser and lost revenue to merchants. Some 3-D Secure authentication processes require the purchaser to complete an authentication registration process for the cardholder's financial account, including agreeing to all terms and conditions presented by 3-D Secure, before the purchaser can proceed with a purchase. Purchasers who are unwilling to undertake the risk or inconvenience of registering their card during a purchase, are forced to abandon the transaction. Moreover, some user terminals, such as those having mobile web browsers, can lack features (e.g., support for window frames and/or pop-ups) necessary for proper operation of a 3-D Secure authentication process.

For these and other reasons, some embodiments disclosed herein are directed to the authentication gateway node 100 generating risk scores for eCommerce authentication requests and selectively providing the eCommerce authentication requests to the authentication node 130 based on the risk scores. The authentication gateway node 100 can be configured to operate on eCommerce authentication requests in-flight before being delivered to the authentication node 130, and control, based on the risk scores, which of the eCommerce authentication requests are processed by the authentication node 130 for authentication of purchasers and generation of authentication responses based on the outcomes of the authentication.

In one embodiment, only eCommerce authentication requests having risk scores that satisfy a defined rule are provided to the authentication node 130 for authentication processing and generation of the authentication responses based on the authentication processing, while other eCommerce authentication requests (having risk scores that do not satisfy the defined rule) bypass authentication processing by the authentication node 130. When bypassing authentication processing by the authentication node 130, the authentication gateway node 100 may generate an authentication response based on the risk score for the eCommerce authentication request (e.g., generate an authentication response indicating that the purchaser was properly authenticated) and communicate the authentication response to the merchant node 120 as if it had originated from the authentication node 130. When the authentication response is generated by the authentication gateway node 100, it may contain the same or similar content to an authentication response generated by the authentication node 130 so that the merchant node 120 is not aware that the authentication response was generated without authentication of the purchaser being performed by the authentication node 130.

When selectively providing the eCommerce authentication request to the authentication node 130, the authentication gateway node 100 may selectively mark the eCommerce authentication request to indicate whether authentication of the purchaser by the authentication node 130 is requested based on whether the risk score satisfies a defined rule. The authentication gateway node 130 then performs authentication processing (e.g., providing authentication challenges to purchasers) for only the eCommerce authentication requests that are marked for authentication. The authentication gateway node 130 can then generate the authentication responses based on a result of the authentication processing when performed, or based on the risk score when authentication processing is not performed.

In another embodiment, when selectively providing the eCommerce authentication request to the authentication node 130, the authentication gateway node 100 selectively routes the eCommerce authentication request to the authentication node 130 for authentication of the purchaser based on whether the risk score satisfies a defined rule. Accordingly, the authentication node 130 performs purchaser authentication processes for each eCommerce authentication request that it receives, however the authentication node 130 only receives eCommerce authentication requests having risk scores that the authentication gateway node 100 determined to satisfy a defined rule (e.g., having a risk score that exceeds a threshold level or alternatively that does not exceed a threshold level).

In another embodiment, the authentication node 130 can include some of the functionality described herein of the authentication gateway node 100. The authentication node 130 can receive all eCommerce authentication requests, but selectively generate an authentication challenge to the user equipment 110 (FIG. 1) to authenticate the purchaser only for eCommerce authentication requests having risk scores that satisfy a defined rule.

Depending upon the risk score, the authentication gateway node 100 may generate a credit/debit account warning message which notifies the credit/debit finance issuer node 140 (e.g., card issuing bank server) that privileges with an account should be halted/frozen (e.g., cancel card) or otherwise modified, and/or may generate a bank account warning message which notifies the bank node 150 (e.g., savings/checking bank server) that privileges with an account should be halted/frozen (e.g., cancel card) or otherwise modified.

Although the authentication gateway node 100 is shown as being separate from the merchant node 120, in some embodiments the authentication gateway node 100 is incorporated into the credit/debit finance issuer node 140 or the merchant node 120 so that at least some of the operations disclosed herein as being performed by the authentication gateway node 100 are performed within the credit/debit finance issuer node 140 or the merchant node 120. Thus for example, the risk scores can be generated internal to the merchant node 120 and used to control when eCommerce authentication requests are communicated to the authentication node 130. The merchant node 120 can use the risk score to selectively send an eCommerce authentication request to the authentication node 130 for authentication of the purchaser when the risk score satisfies a defined rule or send the financial transaction to the acquirer node 122 and credit/debit finance issuer node 140 for verification against the cardholder's account without authentication of the purchaser by the authentication node 130 when the risk score does not satisfy a defined rule.

Similarly, although the authentication gateway node 100 is shown as being separate from the authentication node 130, in some embodiments the authentication gateway node 100 is incorporated into the authentication node 130 so that at least some of the operations disclosed herein as being performed by the authentication gateway node 100 are performed within the authentication node 130. Thus for example, the risk scores can be generated internal to the authentication node 130 and used to control which of the eCommerce authentication requests cause authentication challenges to be generated to purchasers.

The authentication response (e.g., 3-D Secure authentication response code) can be generated by the authentication node 130, based on authentication processes performed with the purchaser and/or may be generated by the authentication gateway node 100 based on the risk score (e.g., without authentication processing by the authentication node 130) and provided to the merchant node 120. The merchant node 120 receives the authentication response and may deny the transaction based on content of the authentication response (e.g., based on the risk score generated by the authentication gateway node 100 and/or based on the result of authentication processes by the authentication node). The merchant node 120 can initiate verification of the transaction by communicating to a credit/debit finance issuer node 140, via an acquirer node 122 (e.g., merchant's bank), the authentication response and content of the eCommerce authentication request (e.g., cardholder information, other content of an eCommerce authentication request disclosed herein, etc).

The acquirer node 122 routes the authentication response and the content of the eCommerce authentication request to a credit/debit finance issuer node 140 (e.g., card issuing bank server such as a Visa or other card server via VisaNet, BankNet, etc.). The credit/debit finance issuer node 140 generates an authorization decision based on whether the account number has a sufficient credit limit and/or existing funds to cover the amount of the financial transaction, and can further generate the authorization decision based on the authentication response from the authentication node 130 and/or the authentication gateway node 100.

The credit/debit finance issuer node 140 communicates its authorization decision to the acquirer node 122, which communicates an authorization decision to the merchant node 120. The merchant node 120 decides whether to complete the transaction with the purchaser or to deny the transaction based on the authorization decision from the acquirer node 122.

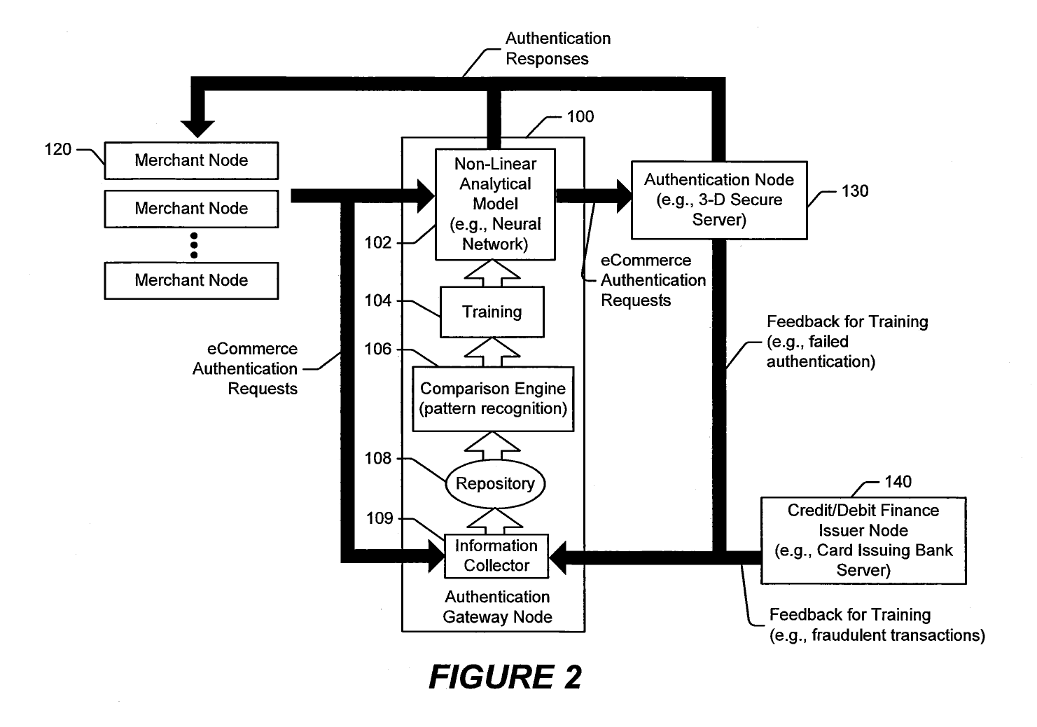

Further example operations by the authentication gateway node 100 are explained below with regard to FIGS. 2-10.

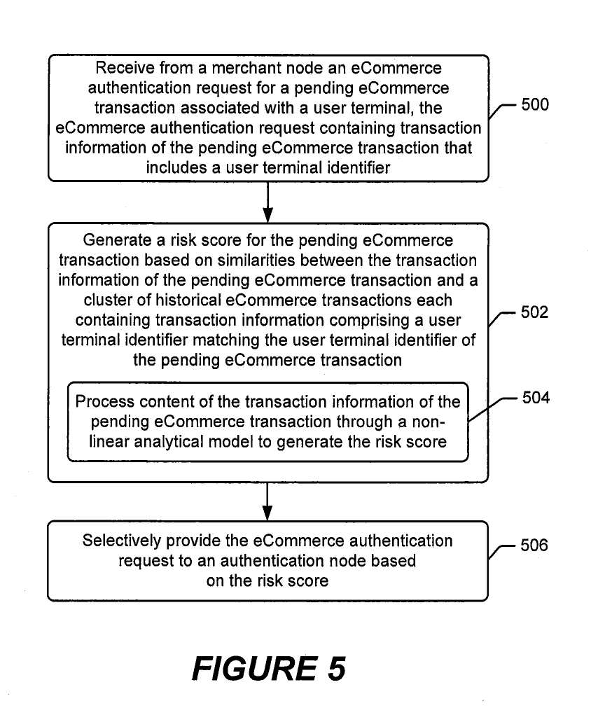

Referring to FIG. 1 and the related flowchart of FIG. 5, the authentication gateway node 100 receives (block 500) an eCommerce authentication request from the merchant node 120 for a pending eCommerce transaction associated with a user terminal. The eCommerce authentication request contains transaction information of the pending eCommerce transaction that comprises a user terminal identifier. As explained above, the user terminal identifier may uniquely identify the user terminal, such as by a telephone number of the user terminal and/or a International Mobile Subscriber Identity of the user terminal. Alternatively or additionally, The user terminal identifier may be a network address associated with the user terminal (e.g., IP address), such as the network address of a network access node (e.g., cable modem, DSL modem, wireless access point, etc), the intermediate routing address of an edge router, and/or another network address that sufficiently defines a group of network locations and/or geographic region from which a user terminal is communicating when performing an eCommerce transaction. The authentication gateway node 100 generates (block 502) a risk score for the pending eCommerce transaction based on similarities between the transaction information of the pending eCommerce transaction and a cluster of historical eCommerce transactions each containing transaction information comprising a user terminal identifier matching the user terminal identifier of the pending eCommerce transaction. Matching of the user terminal identifier of the pending eCommerce transaction and one of the historical eCommerce transactions can include a determination of an identical identifier or a determination that a defined matching rule has been satisfied (e.g., identical network addresses, identical International Mobile Subscriber Identity, less than a threshold distance between their identified geographic locations, etc.). The authentication gateway node 100 selectively provides (block 506) the eCommerce authentication request to the authentication node 130 based on the risk score.

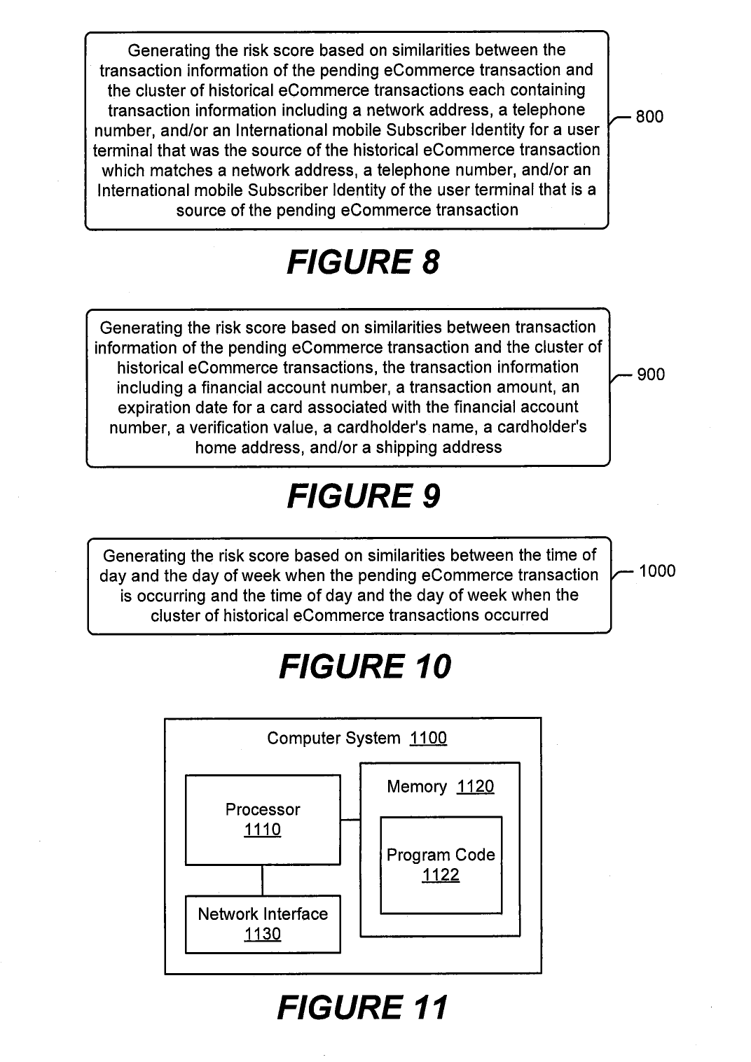

In one embodiment, the authentication gateway node 100 may perform the operations of FIG. 8 to generate the risk score. Referring to FIG. 8, the risk score for the pending eCommerce transaction is generated (block 800) based on similarities between the transaction information of the pending eCommerce transaction and the cluster of historical eCommerce transactions, where the similarities are determined between content of the transaction information that includes a network address, a telephone number, and/or an International mobile Subscriber Identity for a user terminal that was the source of the historical eCommerce transaction which matches the a network address, a telephone number, and/or an International mobile Subscriber Identity of the user terminal that is a source of the pending eCommerce transaction. Accordingly, the risk score can depend upon patterns that are identified between the network address, the telephone number, and/or the International mobile Subscriber Identity for the user terminal was a source of historical eCommerce transactions and the user terminal that is a source of the pending eCommerce transaction.

In another embodiment, the authentication gateway node 100 may perform the operations of FIG. 9 to generate the risk score. Referring to FIG. 9, the risk score for the pending eCommerce transaction is generated (block 900) based on similarities between the transaction information of the pending eCommerce transaction and the cluster of historical eCommerce transactions, where the similarities are determined between content of the transaction information that includes a financial account number, a transaction amount, an expiration date for a card associated with the financial account number, a verification value, the cardholder's name, cardholder's home address, and/or shipping address. Accordingly, the risk score can depend upon patterns that are identified in the financial account number, the transaction amount, the expiration date for a card associated with the financial account number, the verification value, the cardholder's name, the cardholder's home address, and/or the shipping address between the historical eCommerce transactions and the pending eCommerce transaction.

In another embodiment, the authentication gateway node 100 may perform the operations of FIG. 10 to generate the risk score. Referring to FIG. 10, the transaction information of each of the historical eCommerce transactions includes a time of day and a date when the historical eCommerce transaction occurred. The risk score for the pending eCommerce transaction is generated (block 1000) based on similarities between the time of day and/or the day of week when the pending e-commerce transaction is occurring and the time of day and/or the day of week when the cluster of historical e-commerce transactions occurred which are associated with the matching user terminal identifier.

Controlling which eCommerce authentication requests are provided to the authentication node 130 based on the risk scores can effectively prioritize authenticating only the eCommerce authentication requests that appear to have a greater risk of originating from purchasers who are not the account owner or otherwise authorized by the account owner for the purchase. The other eCommerce authentication requests can bypass authentication by the authentication node 130, allowing verification by a credit/debit finance issuer node 140 (e.g., card issuing bank server such as a Visa or MasterCard member bank server) to proceed. Because some, and perhaps most, eCommerce authentication requests are not authenticated by the authentication node 130, e.g., depending upon a rule defining which risk scores cause authentication, merchants can have substantially lower transaction costs (e.g., reduced per-transaction purchaser authentication fees by a reduced number of authenticated transactions) and fewer transaction abandonments due to fewer purchasers being challenged to complete authentication processes.

The authentication gateway node 100 may generate the risk score by processing (block 504 of FIG. 5) content of the transaction information of the pending eCommerce transaction through a non-linear analytical model to generate the risk score.

FIG. 2 is block diagram illustrating further details of the financial transaction processing system of FIG. 1 that uses an authentication gateway node that trains a non-linear analytical model 102 to control selection of eCommerce authentication requests for authentication, to trigger communication of the credit/debit account warning messages to credit/debit finance issuer nodes 140, and/or to trigger communication of the bank account warning messages to bank nodes 150, in accordance with some embodiments.

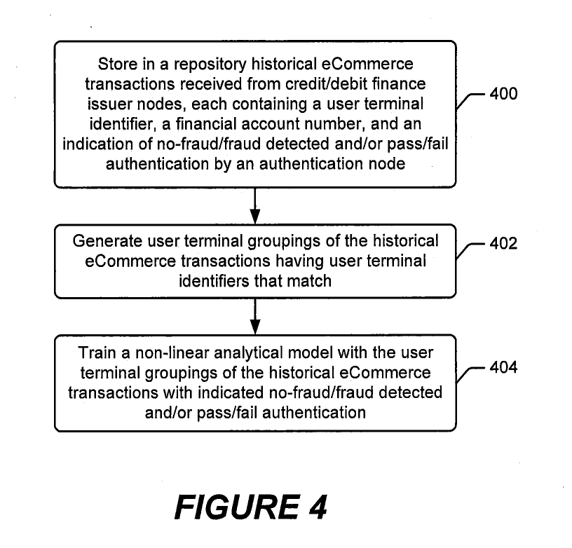

Referring to FIG. 2 and the operational flowchart of FIG. 4, the authentication gateway node 100 receives eCommerce authentication requests for pending eCommerce transactions from a plurality of merchant nodes 120. The authentication gateway node 100 processes content of each of the eCommerce authentication requests through the non-linear analytical model 102 (e.g., a neural network model) to generate risk scores for the pending eCommerce transactions.

The non-linear analytical model 102 has a non-linear relationship that allows different output values to be generated from a sequence of cycles of processing the same input values. Thus, repetitively processing the same input value(s) through the non-linear analytical model 102 can result in output of different corresponding values.

The authentication gateway node 100 includes an information collector 109 that stores (block 400 of FIG. 4) in a repository 108 feedback of historical eCommerce transactions received from finance issuer nodes 140. Each of the historical eCommerce transactions can contain a user terminal identifier, a financial account number, and an indication of whether fraud was detected. The information collector 109 may alternatively or additionally store in the repository 108 feedback of historical eCommerce transactions from the authentication node 130. Each of the historical eCommerce transactions can then contain a user terminal identifier, a financial account number, and an indication of whether an associated historical eCommerce authentication request passed/failed authentication by the authentication node 130.

The repository 108 may additionally or alternatively reside at least partially within the merchant nodes 120 and/or another element of the financial transaction processing system.

A comparison engine 106 generates (block 402 of FIG. 4) user terminal groupings of the historical eCommerce transactions in the repository 108 based on the user terminal identifiers. Each of the historical eCommerce transactions in any one of the user terminal groups having user terminal identifiers that match. The comparison engine 106 may detect patterns or other similarities occurring across content of the historical eCommerce transactions within one or more of the user terminal groups relative to the indications of whether fraud was detected and/or whether the historical eCommerce authentication requests passed authentication by the authentication node 130. Thus, fraud and/or failed authentication that has been observed with detectable patterns of transaction amounts, time of day, day of week, financial account numbers, frequency of transaction occurrence, location, and/or other content of the historical eCommerce transactions having matching user terminal identifiers can be identified. These patterns can be detected across any number of credit/debit finance issuer nodes so that an eCommerce transaction arising from a same user terminal that has previously been the source of other historical eCommerce transactions can be evaluated in light of the fraud and/or authentication history of those historical eCommerce transactions.

Output of the comparison engine 106 can be used by a training circuit 104 (e.g., computer readable program code executed by a processor) to train (block 404 of FIG. 4) the non-linear analytical model 102. The non-linear analytical model 102 may be a neural network model 102. The training circuitry 104 can train the neural network model 102 with content of the historical eCommerce transactions within the user terminal groupings. Accordingly, the patterns of transaction amounts, time of day, day of week, financial account numbers, and/or other content of the historical eCommerce transactions across any number of different financial accounts which are determined to be associated with matching user terminal identifiers can be used to train the neural network model 102.

The training circuitry 104 may furthermore dynamically train (e.g., fine-tune) the neural network model 102 responsive to transaction information that is dynamically received for eCommerce authentication requests. The information collector 109 may receive eCommerce authentication requests from the merchant nodes 120 and may further receive authentication responses from the authentication node 130 indicating whether authentication of identified ones of the eCommerce authentication requests passed or failed the authentication process. The information collector 109 stores the transaction information and any feedback in the repository 108. The comparison engine 106 may identify patterns or other similarities in the transaction information that are associated with a matching user terminal identifier. The training circuitry 104 can use the identified patterns to or dynamically train the neural network model 102 based on recently occurring eCommerce transactions.

As explained above, the transaction information of a pending eCommerce transaction is processed through the neural network model 102 to generate the risk score. The neural network model 102 may, for example, receive hundreds or thousands of simultaneously occurring or nearly simultaneously occurring eCommerce transactions from tens, hundreds, or thousands of different merchant nodes 120, and generate risk scores that are used to determine which of the eCommerce authentication requests will be processed by the authentication node 130 to authenticate associated purchasers (or other persons) associated with the eCommerce authentication requests and/or to selectively communicate credit/debit account warning messages and/or bank account warning messages.

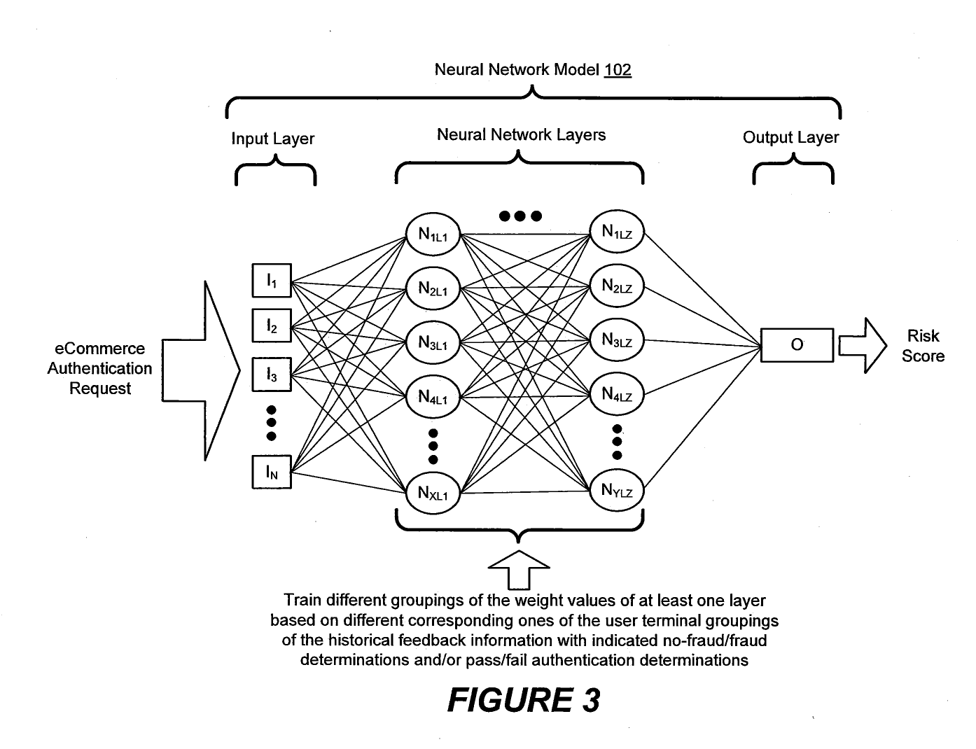

FIG. 3 is a block diagram of a neural network model 102 that can be used in an authentication gateway node 100 to generate a risk score for an eCommerce authentication request. Referring to FIG. 3, the neural network model 102 includes an input layer having a plurality of input nodes, a sequence of neural network layers each including a plurality of weight nodes, and an output layer including an output node. In the particular non-limiting example of FIG. 3, the input layer includes input nodes I₁ to I_{N} (where N is any plural integer). A first one of the sequence of neural network layers includes weight nodes N_{1L1} (where “1L1” refers to a first weight node on layer one) to N_{XL1} (where X is any plural integer). A last one (“Z”) of the sequence of neural network layers includes weight nodes N_{1LZ} (where Z is any plural integer) to N_{YLZ} (where Y is any plural integer). The output layer includes an output node O.

The neural network model 102 of FIG. 3 is an example that has been provided for ease of illustration and explanation of one embodiment. Other embodiments may include any non-zero number of input layers having any non-zero number of input nodes, any non-zero number of neural network layers having a plural number of weight nodes, and any non-zero number of output layers having any non-zero number of output nodes. The number of input nodes can be selected based on the number of eCommerce authentication requests that are to be simultaneously processed, and the number of output nodes can be similarly selected based on the number of risk scores that are to be simultaneously generated therefrom.

The neural network model 1Q2 can be operated to process different content of the transaction information of the pending eCommerce transaction through different inputs (e.g., input nodes I₁ to I_{N}) of the neural network model 102. Content of the transaction information that can be simultaneously processed through different input nodes I₁ to I_{N} may include any one or more of:
1) purchaser's user terminal identifier (e.g., network address of the user terminal, telephone number of the user terminal, and/or International Mobile Subscriber Identity of the user terminal);
2) account number (e.g., credit/debit card number);
3) expiration date for the card;
4) verification value (e.g., CVV);
5) cardholder's name;
6) the cardholder's home address;
7) the purchaser's shipping address;
8) characteristics of the purchaser's user terminal (e.g., manufacturer, web browser characteristics, and/or operational characteristics);
9) geographic region of the purchaser's user terminal;
10) amount of the financial transaction;
11) identifier for the merchant node 120;
12) a geographic region of the merchant node 120;
13) identifier for the acquirer node 122;
14) time of transaction; and
15) date and/or day of week of transaction.

By way of example, the purchaser's user terminal identifier can be provided to input node I₁, the account number can be provided to input node I₂, the expiration date for the card can be provided to input node I₃, the amount of the financial transaction can be provided to input node I₄, the identifier for the merchant node 120 can be provided to input node I₅, the purchaser's name can be provided to input node I₆, the time of transaction can be provided to input node I₇, the date and/or day of week of transaction can be provided to input node I₈, the purchaser's shipping address can be provided to input node I₉, a geographic region of the merchant node 120 can be provided to input node I₁₀, a geographic region of the user terminal 110 can be provided to input node I₁₁, a cardholder's home address can be provided to input node I₁₂, and characteristics of the user terminal 110 can be provided to input node I₁₃.

Items of content of other eCommerce authentication requests occurring simultaneously or within a threshold time can be similarly provided to further groups of input nodes (e.g., group I₁₄-I₂₆, group I₂₇-I₃₉, etc.). In this particular example, the content items associated with 100 different eCommerce authentication requests can be simultaneously or nearly simultaneously provided to an array of 1300 input nodes I (e.g., 100 eCommerce authentication requests, each having 13 content items). The weight nodes N of a plurality of neural network layers can process values output by the input nodes I to generate combined values that are provided to an array of output nodes O. The number of output nodes may be the same as the number of eCommerce authentication requests that are simultaneously processed by the neural network model 102, with each of the output nodes outputting a risk score for a different one of the eCommerce authentication requests. Thus, when the neural network model 102 is configured to simultaneously process 100 different eCommerce authentication request, 100 output nodes O can be provided to each output a risk score for a different one of the 100 eCommerce authentication requests.

The interconnected structure between the input nodes, the weight nodes of the neural network layers, and the output nodes causes the characteristics of each eCommerce authentication request to influence the risk score generated for all of the other eCommerce authentication requests that are simultaneously processed. The risk scores generated by the neural network model 102 may thereby identify a comparative prioritization of which of the eCommerce authentication requests have characteristics that provide a higher/lower likelihood of their failing/passing authentication if provided to the authentication node 130, or otherwise indicate a level of trustworthiness that the eCommerce authentication request originated from the account owner or another person authorized by the account owner. The authentication gateway node 100 can thereby select a group of the eCommerce authentication requests having an upper or lower range of the generated risk scores, and provide the selected group of eCommerce authentication request to the authentication node 130 for authentication processing. In sharp contrast, the other eCommerce authentication requests outside the selected group are not provided to the authentication node 130 for authentication processing, but instead have authentication responses generated based on their credit scores.

The neural network model 102 operates to mathematically combine values of the items of content from defined ones of the inputs of the neural network using weight values to generate a risk score for each of the plurality of eCommerce authentication requests (e.g., sum values of the content items to generate a summed value that is multiplied by a weight value to generate the risk score). The neural network model 102 or other component of the authentication gateway node 100 may select eCommerce authentication requests from among the plurality of eCommerce authentication requests received within the threshold time to provide to the authentication node based on comparison of the risk scores. The authentication gateway node 100 may additionally use the risk scores to determine when the credit/debit account warning messages and/or the bank account warning messages are to be communicated related to which of the financial accounts.

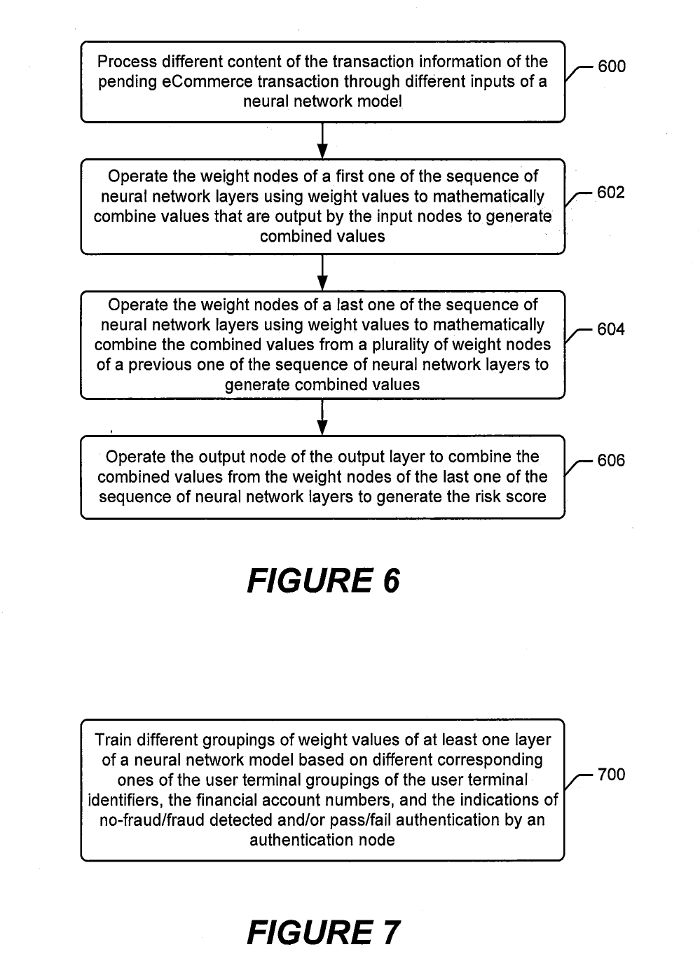

More particular example operations that may be performed by the neural network model 102 of FIG. 3 are illustrated in the flowchart of FIG. 6. The operations can include processing (block 600) different content of the transaction information of the pending eCommerce transaction through different inputs of the neural network model 102. The neural network model 102 operates (block 602) the weight nodes of the first one of the sequence of neural network layers using weight values to mathematically combine values that are output by the input nodes to generate combined values. Each of the weight nodes of the first layer may, for example, sum the values that are output by the input nodes, and multiply the summed result by a weight value that can be separately defined for each of the weight nodes (and may thereby be different between the weight nodes on a same layer) to generate one of the combined values.

The neural network model 102 operates (block 604) the weight nodes of the last one of the sequence of neural network layers using weight values to mathematically combine the combined values from a plurality of weight nodes of a previous one of the sequence of neural network layers to generate combined values. Each of the weight nodes of the last layer may, for example, sum the combined values from a plurality of weight nodes of a previous one of the sequence of neural network layers, and multiply the summed result by a weight value that can be separately defined for each of the weight nodes (and may thereby be different between the weight nodes on a same layer) to generate one of the combined values.

The neural network model 102 operates (block 606) the output node “O” of the output layer to combine the combined values from the weight nodes of the last one of the sequence of neural network layers to generate the risk score.

As explained above with regard to FIG. 4, user terminal groupings can be generated (block 402) for the historical eCommerce transactions having user terminal identifiers that match. The neural network model 102 can be trained (block 402) with the user terminal groupings of the historical eCommerce transactions.

When feedback of historical eCommerce transactions with indicated fraud and/or no-fraud determinations is received from credit/debit finance issuer nodes 140, the neural network model 102 can be trained based on at least the user terminal identifiers, the financial account numbers, and the indications of whether fraud was detected for each of the user terminal groupings of the historical eCommerce transactions. In the embodiment of FIG. 3, different groupings of the weight values of at least one of the neural network layers can be trained based on different corresponding ones of the user terminal groupings of the user terminal identifiers, the financial account numbers, and the indications of whether fraud was detected for the historical eCommerce transactions. For example, weight values of one layer may be trained based on the user terminal identifiers, weight values of another layer may be trained based on the financial account numbers, weight values of another layer may be trained based on the indications of whether fraud was detected for the historical eCommerce transactions, and so on with different other content of eCommerce transaction information being provided to training the weight values of different layers of the neural network model 102.

Alternatively or additionally, when feedback of historical eCommerce transactions with indicated passed and/or failed authentication determinations is received from one or more authentication nodes 130, the neural network model 102 can be trained based on at least the user terminal identifiers, the financial account number, and the indications of whether the associated historical eCommerce authentication requests passed authentication by the authentication node. In the embodiment of FIG. 3, different groupings of the weight values of at least one of the neural network layers can be trained based on different corresponding ones of the user terminal groupings of the user terminal identifiers, the financial account numbers, and the indications of whether the associated historical eCommerce authentication requests passed authentication by the authentication node. For example, weight values of one layer may be trained based on the user terminal identifiers, weight values of another layer may be trained based on the financial account numbers, weight values of another layer may be trained based on the indications of whether the associated historical eCommerce authentication requests passed authentication by the authentication node, and so on with different other content of eCommerce transaction information being provided to train the weight values of different layers of the neural network model 102.

The neural network model may be alternatively or additionally be trained based on patterns identified among the user terminal clusters of historical eCommerce transactions have one or more of the following characteristics:
1) generated by the acquirer node 122 at a rate that is outside an expected range (e.g., greater than a historical observed upper rate from the acquirer node 122 for a particular time of day and/or day or week/year);
2) associated with a same user terminal 110 and occurring at a rate that greater than an expected rate arising from the same user terminal (e.g., indication that eCommerce authentication requests are being electronically generated by a possibly malicious program instead of by a human purchaser);
3) associated with a same merchant node 120 and occurring at a rate that is outside an expected range (e.g., greater than a historical observed upper rate from the merchant node 120 and/or other merchant nodes having similar characteristics as the merchant node 120 for a particular time of day and/or day or week/year); and
4) arising from a same geographic region, such as geographic region of the user terminal 110, the merchant node 120, the acquirer node 122, and/or the credit/debit finance issuer node 140, and occurring at a rate that is outside an expected range (e.g., greater than a historical observed upper rate for a particular time of day and/or day or week/year).

The neural network model may, for example, receive hundreds or thousands of simultaneously occurring or nearly simultaneously occurring eCommerce authentication requests from tens, hundreds, or thousands of different merchant nodes 120, and generate risk scores that are used to determine which of the eCommerce authentication requests will be processed by the authentication node 130 to authenticate associated purchasers (or other persons) associated with the eCommerce authentication requests.

Alternatively or additionally, the neural network model may, for example, receive hundreds or thousands of sequentially occurring eCommerce authentication requests from a same one of the merchant nodes 120, and generate risk scores for each of the eCommerce authentication requests based on content of previous occurring ones of the eCommerce authentication requests in sequence.

Although various embodiments have been disclosed herein for training the neural network model or, more generally, the non-linear analytical model 102 while it is processing eCommerce authentication requests from merchant nodes 120 which are operationally waiting for corresponding authentication responses, in some other embodiments the training is performed offline. For example, the training may be performed during production of the non-linear analytical model 102 before its incorporation into an operational authentication gateway node 100 and/or the training may be performed while an authentication gateway node 100 is not actively processing eCommerce authentication requests from merchant nodes 120 awaiting authentication responses, such as while maintenance or other offline processes are performed on the authentication gateway node 100.

FIG. 11 is a block diagram of a computer system 1100 that may be used as an authentication gateway node 100, an authentication node 130, a merchant node 120, an acquirer node 122, a user terminal 110, and/or a credit/debit finance issuer node 140 to perform the operations of one of more of the embodiments disclosed herein for one or more of those elements. The computer system 1100 can include one or more network interface circuits 1130, one or more processor circuits 1110 (referred to as “processor” for brevity), and one or more memory circuits 1120 (referred to as “memory” for brevity) containing program code 1122.

The processor 1110 may include one or more data processing circuits, such as a general purpose and/or special purpose processor (e.g., microprocessor and/or digital signal processor) that may be collocated or distributed across one or more networks. The processor 1110 is configured to execute program code 1122 in the memory 1120, described below as a computer readable storage medium, to perform some or all of the operations for one or more of the embodiments disclosed herein.

A neural network of the authentication gateway node 100 may be implemented by the program code 1122 executed by the processor 1110 and/or may be implemented by other circuits that can include, but are not limited to, a digital gate array and/or analog circuits.

### FURTHER DEFINITIONS AND EMBODIMENTS

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method of operating a computer system comprising:
receiving from a merchant node an eCommerce authentication request for a pending eCommerce transaction associated with a user terminal, the eCommerce authentication request containing transaction information of the pending eCommerce transaction that comprises a user terminal identifier;
generating a risk score for the pending eCommerce transaction based on similarities between the transaction information of the pending eCommerce transaction and a cluster of historical eCommerce transactions each containing transaction information comprising a user terminal identifier matching the user terminal identifier of the pending eCommerce transaction; and
selectively providing the eCommerce authentication request to an authentication node based on the risk score.

2. The method of claim 1, further comprising:
storing in a repository the historical eCommerce transactions received from finance issuer nodes, each of the historical eCommerce transactions containing a user terminal identifier, a financial account number, and an indications of whether fraud was detected;
generating user terminal groupings of the historical eCommerce transactions in the repository based on the user terminal identifiers, each of the historical eCommerce transactions in any one of the user terminal groups having user terminal identifiers that match; and
training a non-linear analytical model with the user terminal groupings of the historical eCommerce transactions,
wherein the generating a risk score comprises:
processing the transaction information of the pending eCommerce transaction through the non-linear analytical model to generate the risk score.

3. The method of claim 2, wherein the training the non-linear analytical model with the user terminal groupings of the historical eCommerce transactions, comprises.
training a neural network model based on the user terminal identifiers, the financial account number, and the indications of whether fraud was detected for each of the user terminal groupings of the historical eCommerce transactions.

4. The method of claim 3,
wherein the neural network model comprises an input layer comprising input nodes, a sequence of neural network layers each comprising a plurality of weight nodes, and an output layer comprising an output node;
the method further comprising:
operating the input nodes of the input layer to each receive different content of the transaction information of the pending eCommerce transaction and output a value;
operating the weight nodes of a first one of the sequence of neural network layers using weight values to mathematically combine values that are output by the input nodes to generate combined values;
operating the weight nodes of a last one of the sequence of neural network layers using weight values to mathematically combine the combined values from a plurality of weight nodes of a previous one of the sequence of neural network layers to generate combined values; and
operating the output node of the output layer to combine the combined values from the weight nodes of the last one of the sequence of neural network layers to generate the risk score.

5. The method of claim 4, wherein the training the neural network model based on the user terminal identifiers, the financial account numbers, and the indications of whether fraud was detected for each of the user terminal groupings of the historical eCommerce transactions, comprises
training different groupings of the weight values of at least one of the neural network layers based on different corresponding ones of the user terminal groupings of the user terminal identifiers, the financial account numbers, and the indications of whether fraud was detected for the historical eCommerce transactions.

6. The method of claim 1, further comprising:
storing in a repository the historical eCommerce transactions from the authentication node, each of the historical eCommerce transactions containing a user terminal identifier, a financial account number, and an indication of whether an associated historical eCommerce authentication request passed authentication by the authentication node;
generating user terminal groupings of the historical eCommerce transactions in the repository based on the user terminal identifiers, each of the historical eCommerce transactions in any one of the user terminal groups having user terminal identifiers that match; and
training a non-linear analytical model with the user terminal groupings of the historical eCommerce transactions,
wherein the generating a risk score comprises:
processing the transaction information of the pending eCommerce transaction through the non-linear analytical model to generate the risk score.

7. The method of claim 6, wherein the training the non-linear analytical model with the user terminal groupings of the historical eCommerce transactions, comprises.
training a neural network model based on the user terminal identifiers, the financial account numbers, and the indications of whether associated historical eCommerce authentication requests passed authentication by the authentication node for each of the user terminal groupings of the historical eCommerce transactions.

8. The method of claim 7,
wherein the neural network model comprises an input layer comprising input nodes, a sequence of neural network layers each comprising a plurality of weight nodes, and an output layer comprising an output node;
the method further comprising:
operating the input nodes of the input layer to each receive different content of the transaction information of the pending eCommerce transaction and output a value;
operating the weight nodes of a first one of the sequence of neural network layers using weight values to mathematically combine values that are output by the input nodes to generate combined values;
operating the weight nodes of a last one of the sequence of neural network layers using weight values to mathematically combine the combined values from a plurality of weight nodes of a previous one of the sequence of neural network layers to generate combined values; and
operating the output node of the output layer to combine the combined values from the weight nodes of the last one of the sequence of neural network layers to generate the risk score.

9. The method of claim 8, wherein the training the neural network model based on the user terminal identifiers, the financial account numbers, and the indications of whether associated historical eCommerce authentication requests passed authentication by the authentication node for each of the user terminal groupings of the historical eCommerce transactions, comprises
training different groupings of the weight values of at least one of the neural network layers based on different corresponding ones of the user terminal groupings of the user terminal identifiers, the financial account numbers, and the indications of whether associated historical eCommerce authentication requests passed authentication by the authentication node.

10. The method of claim 1, wherein:
the user terminal identifier comprises a network address of a user terminal that is a source of the pending eCommerce transaction; and
the risk score for the pending eCommerce transaction is generated based on similarities between the transaction information of the pending eCommerce transaction and the cluster of historical eCommerce transactions each containing transaction information comprising a network address for a user terminal that was the source of the historical eCommerce transaction which matches the network address of the user terminal that is a source of the pending eCommerce transaction.

11. The method of claim 1, wherein:
the user terminal identifier comprises a telephone number of a user terminal that is a source of the pending eCommerce transaction; and
the risk score for the pending eCommerce transaction is generated based on similarities between the transaction information of the pending eCommerce transaction and the cluster of historical eCommerce transactions each containing transaction information comprising a telephone number for a user terminal that was the source of the historical eCommerce transaction which matches the telephone number of the user terminal that is a source of the pending eCommerce transaction.

12. The method of claim 1, wherein:
the user terminal identifier comprises an International Mobile Subscriber Identity of a user terminal that is a source of the pending eCommerce transaction; and
the risk score for the pending eCommerce transaction is generated based on similarities between the transaction information of the pending eCommerce transaction and the cluster of historical eCommerce transactions each containing transaction information comprising an International mobile Subscriber Identity for a user terminal that was the source of the historical eCommerce transaction which matches the International mobile Subscriber Identity of the user terminal that is a source of the pending eCommerce transaction.

13. The method of claim 1, wherein:
the transaction information of each of the eCommerce transaction and the historical eCommerce transactions comprises a financial account number and a transaction amount; and
the risk score for the pending eCommerce transaction is generated based on similarities between the financial account number and the transaction amount contained in the transaction information of the pending eCommerce transaction and the cluster of historical eCommerce transactions.

14. The method of claim 13, wherein:
the transaction information of each of the historical eCommerce transactions comprises a time of day and a date when the historical eCommerce transaction occurred; and
the risk score for the pending eCommerce transaction is generated based on similarities between a time of day and a day of week when the pending eCommerce transaction is occurring and the time of day and the day of week when the cluster of historical eCommerce transactions occurred.

15. The method of claim 13, wherein:
the transaction information of each of the eCommerce transaction and the historical eCommerce transactions comprises an expiration date for a card associated with the financial account number, a verification value, a cardholder's name, a cardholder's home address, and a shipping address; and
the risk score for the pending eCommerce transaction is generated based on similarities between the expiration date, the verification value, the cardholder's name, the cardholder's home address, and the shipping address contained in the transaction information of the pending eCommerce transaction and the cluster of historical eCommerce transactions.

16. The method of claim 1, wherein the selectively providing the eCommerce authentication request to the authentication node based on the risk score, comprises:
selectively marking the eCommerce authentication request to indicate whether authentication of a person, who is associated with the eCommerce authentication request, by the authentication node is requested based on whether the risk score satisfies a defined rule.

17. The method of claim 1, wherein the selectively providing the eCommerce authentication request to the authentication node based on the risk score, comprises:
selectively routing the eCommerce authentication request to the authentication node for authentication of a person, who is associated with the eCommerce authentication request, based on whether the risk score satisfies a defined rule.

18. An authentication gateway node comprising:
a processor; and
a memory coupled to the processor and comprising computer readable program code that when executed by the processor causes the processor to perform operations comprising:
receiving from a merchant node an eCommerce authentication request for a pending eCommerce transaction associated with a user terminal, the eCommerce authentication request containing transaction information of the pending eCommerce transaction that comprises a user terminal identifier;
generating a risk score for the pending eCommerce transaction based on similarities between the transaction information of the pending eCommerce transaction and a cluster of historical eCommerce transactions each containing transaction information comprising a user terminal identifier matching the user terminal identifier of the pending eCommerce transaction; and
selectively providing the eCommerce authentication request to an authentication node based on the risk score.

19. The authentication gateway node of claim 18, wherein the memory further comprises computer readable program code that when executed by the processor causes the processor to perform operations comprising:
storing in a repository the historical eCommerce transactions received from finance issuer nodes, each of the historical eCommerce transactions containing a user terminal identifier, a financial account number, and an indications of whether fraud was detected;
generating user terminal groupings of the historical eCommerce transactions in the repository based on the user terminal identifiers, each of the historical eCommerce transactions in any one of the user terminal groups having user terminal identifiers that match; and
training a non-linear analytical model with the user terminal groupings of the historical eCommerce transactions,
wherein the generating a risk score comprises:
processing the transaction information of the pending eCommerce transaction through the non-linear analytical model to generate the risk score.

20. A computer program product comprising:
a computer readable storage medium having computer readable program code embodied in the medium that when executed by a processor of a computer system causes the computer system to perform operations comprising:
receiving from a merchant node an eCommerce authentication request for a pending eCommerce transaction associated with a user terminal, the eCommerce authentication request containing transaction information of the pending eCommerce transaction that comprises a user terminal identifier;
generating a risk score for the pending eCommerce transaction based on similarities between the transaction information of the pending eCommerce transaction and a cluster of historical eCommerce transactions each containing transaction information comprising a user terminal identifier matching the user terminal identifier of the pending eCommerce transaction; and
selectively providing the eCommerce authentication request to an authentication node based on the risk score.
